(19) United States
(12) Patent Application Publication
(10) Pub. No.: US 2009/0271765 A1
(43) Pub. Date: Oct. 29, 2009

(54) CONSUMER AND PRODUCER SPECIFIC SEMANTICS OF SHARED OBJECT PROTOCOLS

(75) Inventors: James Hugunin, Mercer island, WA (US); Robert E. Viehland, Seattle, WA (US); Martin Maly, Seattle, WA (US); William P. Chiles, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/111,664

(22) Filed: Apr. 29, 2008

(51) Int. Cl. G06F 9/44

(52) U.S. Cl. 717/116

(57) ABSTRACT

Determining how to perform operations specified in executable code. A method may include accessing a language context. The language context is related to a consumer location in executable code. The language context specifies an operation to be performed on one or more objects. The method includes sending a message requesting information about how to perform the operation on the one or more objects. A meta-object is received. The meta-object includes or produces executable code, that when executed performs the operation on the one or more objects.

### BACKGROUND

### BACKGROUND AND RELEVANT ART

Computers and computing systems have affected nearly every aspect of modern living. Computers are generally involved in work, recreation, healthcare, transportation, entertainment, household management, etc.

There are currently a number of different programming languages used to program computers to realize appropriate computer functionality. Some of these programming languages are dynamically typed languages. Currently there are difficulties sharing objects between languages. For example, it may be difficult to perform an operation written in one language on two objects each written in their own programming language. For example, the operation “+” may in some programming languages and language contexts direct two integers objects to be added together. In other programming languages and language contexts, it may direct a binary “OR” operation to be performed. In still other programming languages and language contexts, it may direct conversion of strings to integers and a subsequent addition of the integers.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Some embodiments described herein may include functionality for determining how to perform operations specified in executable code. A method may include accessing a language context. The language context relates to a consumer location in executable code. The code specifies an operation to be performed on one or more objects, and the language context represents the language and may, in some instances, determine the language specific semantics. The method includes sending a message, such as by making a function call, requesting information about how to perform the operation on the one or more objects. A meta-object is received. The meta-object may include, or can produce upon request executable code, that when executed performs the operation on the one or more objects. This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment where various embodiments may be implemented;

FIG. 2 illustrates a method of determining how to perform an operation.

### DETAILED DESCRIPTION

Some embodiments described herein include functionality for allowing operations to be performed among objects of different programming languages. This is accomplished through the use of meta-objects, where the meta-objects include information about how to perform a given operation. In some embodiments, the meta-object may include, or produce one or more actions in the form of executable code, that when executed, perform the operation. Meta-objects can be discovered by querying frameworks, language contexts, objects on which the operations will be performed, etc. Meta-objects may further include or produce a test, in addition to the actions. The test allows for the test and actions to be cached such that after a first query, the test can be evaluated when an operation is subsequently encountered to determine whether to perform the actions of the meta-object rather than querying for the meta-object again. Meta-objects may include a validation method. The validation method allows for caches to query if the test will always fail in the future. Cached actions can be removed from the cache it is determined that the test will always fail in the future.

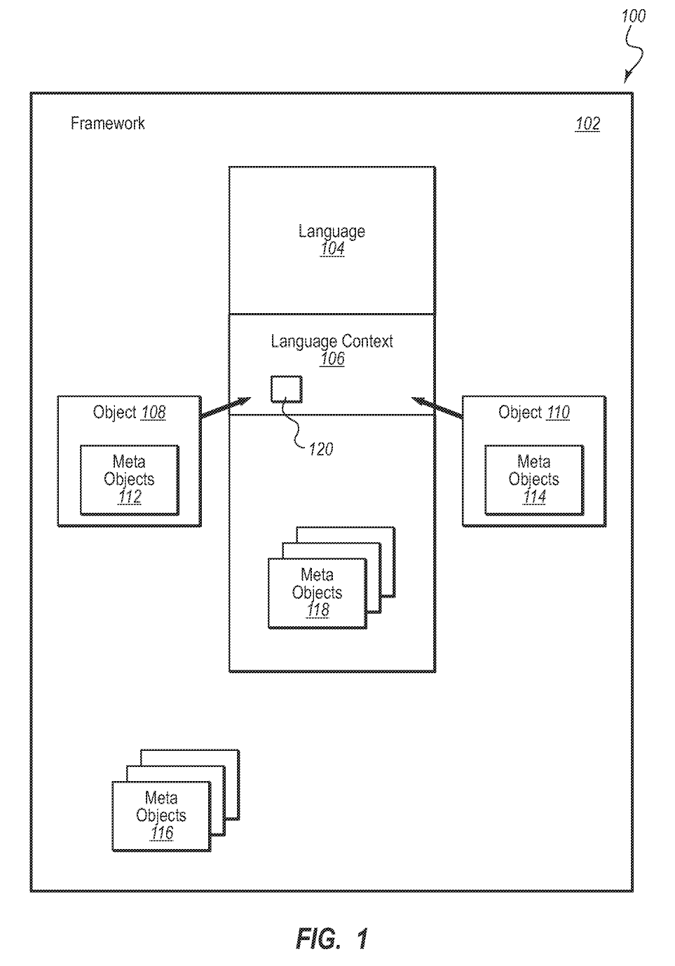

Some embodiments may include a common infrastructure for quickly implementing dynamic languages on a common language runtime (CLR) such as the .NET® CLR available from Microsoft Corporation of Redmond Wash. A system may be implemented for sharing objects in the runtime between multiple programming languages. In this way objects (produced by any of the multiple programming languages) can participate in operations performed by various language instantiations (consumers). For example, FIG. 1 illustrates a CLR framework 102. A language 104, may be used to create consumer code that consumes objects. The language is executing in the framework 102. The language 104 includes a number of language contexts such as language context 106. A language context 106 is associated with a consumer location in the language code 104. A language 106 context could be conceptualized as being associated with a code location or site binder. The language context 106 applies the language 104 to the consumer location. For example, a language 104 may allow for selectable options and the language context 106 may define the selection of one or more options as it relates to a consumer location in code. The language context 106 may be associated with code that specifies an operation to be performed on an object 108 and an object 110. Thus the language context 106 is associated with a consumer locatin of the objects 108 and 110. Embodiments are configured to allow the language context object 106, the object 108, and object 110 to be produced in different programming languages.

Objects may include information expressing how to perform specific operations on themselves. For example, the objects 108 and 110 each include a meta-object 112 and 114 respectively. Meta objects may include or produce actions to be performed and tests as described above.

When an object cannot participate in an operation directly, it might have other operations it supports on which a language 104 could construct a means for performing the original operation on the object. Instructions for performing these other operations may be included in the actions of the meta-object.

Languages, such as language 104, may need a way to override or perform new operations on objects, such as objects 108 and 110, when the languages 104 need to ensure certain language-specific semantics of operations. This functionality will be described further herein below.

Objects produced by static programming languages or existing in static frameworks may also need to participate in the shared object system. The producers of those static objects may explicitly enable the objects to participate in the shared object system for dynamic programming languages by supplying appropriate meta-objects. Additionally, a dynamic language runtime (DLR) might provide some default or basic interoperability for those static objects as defined in meta-objects for the DLR, such as the set 116 of meta-objects for the framework 102. Consuming languages 104 may also specifically recognize types of objects and provide specialized handling or semantics for operations on those objects by using meta-objects, such as the set 118 of meta-objects illustrated for the language 104.

In one embodiment a DLR enables meta-objects that can produce expression trees that capture the behaviors of common operations on objects. Expression trees may be fully capable of expressing general computations when capturing the behaviors of common operations on objects. These common operations are calls such as GetMember, SetIndex, DoOperationPlus, Call, and so on. The expression trees, which may come from any meta-object from any consumer or producer, may be abstract semantic trees representing code that can be manipulated and combined for various optimization effects, can be simply interpreted, or can be compiled and executed as needed to perform the specified operation on an object.

There are several ways to get meta-objects. A program that contains code that turns into one of the DLR's common operations is associated with a language 104. The language context 106 is associated with a runtime object and can produce meta-objects 120 given a common operation and some arguments. The resulting meta-object 120 can be used to produce an expression tree that manifests logic to perform the operation. The language context 106 might call on the argument objects 108 and 110 themselves in turn to discover if any of them can produce a meta-object 112 and 114 respectively, that may include information about how to perform, or instructions for performing, the requested operation. The language context 106 may also call on default helper objects provided by the DLR to see if any of those objects can produce meta-objects, such as meta-objects 116 of the framework 102, for the operation and its arguments. The language context 106 may discover other default objects or extensions to objects via various mechanisms, and these other objects may produce meta-objects for the operations and arguments.

These possible searches for meta-objects allow for the producer of an object (for example, any language or framework) to control the behavior of operations on the object because the object is able to produce its own meta-object. These searches allow for the consumer of the object (that is, any language) to override or produce its own meta-object for the operation. The DLR or any framework that may have generated the object that the operation is targeting can provide mechanisms and extensions to objects (dynamic or static objects) that language contexts can find for producing special meta-objects.

Illustrating now a more specific example, if an operation “+” is called at a consumer location object associated with language context 106 on two objects, such as object 108 and 110, either object may be coded to return a meta-object 112 and 114 respectively that includes actions for performing the “+” operation with the other object. The language context 106 in which the “+” expression of the operation occurred may also produce a meta-object 120 that can perform the “+” operation given the two objects 108 and 110. Additionally, while the language context 106 or the language 104 may receive meta-objects 112 and 114 from the objects 108 and 110, the language context 106 may nonetheless override the behavior proscribed by the objects in the meta-objects 112 and 114 based on runtime options defined by framework meta-objects (e.g. one or more of set 116) other extensions of the language 104 implementation, such as extensions that provide one or more meta-objects from the set 118. For example, as a default behavior, the DLR might provide a meta-object from the set 116 of meta-objects that implements the operation so that neither the objects 108 and 110, nor the language 104 need to do anything specifically. While the language context 106 may choose to fall upon this default behavior, the language context 106 can also ignore it if it so chooses. It should be noted however that in some embodiments the language context 106 may include functionality for the final decision as to how operations are performed on objects 108 and 110. This may include providing a meta-object 120 that includes actions from one or more of the meta-objects 112, 114, or from one or more meta-object from the sets 116 or 118.

Another example is now illustrated. In the present example, a “foo” member of an object, such as object 108, may exist. The present example includes invoking the “foo” member of the object and describes how to find the named member “foo”. The member may not explicitly or concretely be a member of the object 108. Rather, the member may be manifested virtually by the object 108. Alternatively, the member may be manifested virtually by the language 104. Alternatively, the member may be applied virtually or late bound by an extension, described in a meta-object, that the language or the DLR can discover by various mechanisms. The extension would then manifest the name “foo” on the object, and the extension would be the implementation of operations such as GetMember or Invoke operations.

In one embodiment, discovery of a meta-object may be performed by calling on a known object, such as an object associated with the language context 106, that knows how to perform a search for meta-objects. This may result in searching for consumer-provided object, such as a language binder, searching default behaviors in the system, searching extensions applied to objects' types, and so on. This may result in having access to a number of different meta-objects, such as one or more of meta-objects 112, 114, or one or more meta-object from the sets 116 or 118, any or all of which can then be used to create a meta-object 120 defining actions for performing a given operation. Additionally, the language context 106 could override all other meta-objects and instead provide a meta-object 120 based on the language contexts' knowledge of how to perform a given operation.

As noted previously, embodiments may use runtime caching of objects' tests and actions that are sited with consumer-created objects (i.e. associated with language contexts 106) that perform searches. In particular, by caching a meta-object's tests and actions, a test for the meta-object can be used to determine if it is appropriate to use the executable instructions for the meta-object to perform the actions of the meta-object rather than searching for a meta-object again and computing the tests and rules that perform the operation. For example, if an operation is encountered, and it can be determined that a meta-object has already been discovered and cached for the operation, then the cached meta-object can be used to perform the operation. A test for the meta-object can be used to determine if the meta-object is appropriate for the operation. The test may include, for example, reference to operands (e.g. objects being operated on) and/or their characteristics or other information as appropriate. Note that a caching mechanism may or may not be used with any meta-object discoverability or searching mechanisms.

One embodiment includes the ability to query an object for how it performs specific operations. Additionally, embodiments may or may not override any discovery by querying the object for various reasons to ensure appropriate semantics for the operation on the object given the consumer's needs.

One embodiment may include functionality for using extension methods or members added to objects statically after the implementation of those objects have been fully compiled and delivered to consumers. In this embodiment, a meta-object may detect the extension method and provide access to it as a result of an action. The meta-object may or may not override behaviors implemented in the argument objects or with the extensions. The extensions may simply be additive. The meta-object may call on the language context 106 to get extensions. The language context may add extensions based upon the language, or end-user programmer. The language context may also add extension members from a call on default helper objects provided by the DLR to work smoothly in shared object protocols for the DLR.

One embodiment includes functionality for using a runtime object to represent a generalized call site (that is, a location in the code where it performs an operation on one or more objects such as ‘+’, call a member, index the object with another object, etc.). One version of this embodiment includes functionality to site the runtime object with another object that brings to bear certain behaviors, searches, or specializations to searches for the particular call site. This sited object might represent the language context 106 or the semantics of the language that directly or indirectly produced the call site by compiling code. This sited object might be a representation of some static information discovered while emitting the code, and this sited object may directly perform searches for meta-objects, provide information to the language context 106, or just capture static information that can be used to tune the search for meta-objects or the resulting expression tree that ultimately manifests the operation on the arguments presented to the call site.

The following discussion now refers to a number of method acts that may be performed. It should be noted, that although the method acts may be discussed in a certain order, no particular ordering is necessarily required unless specifically stated, or required because an act is dependent on another act being completed prior to the act being performed.

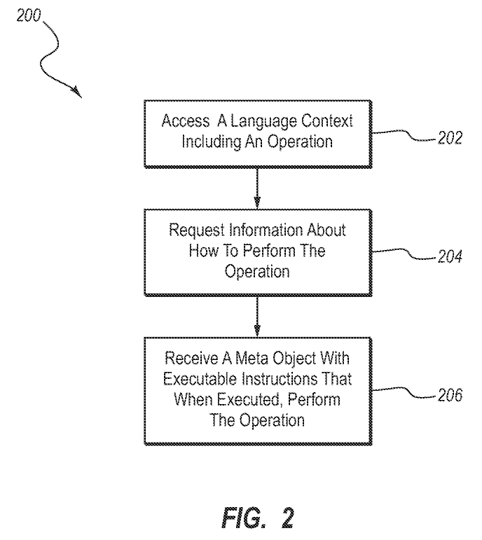

Referring now to FIG. 2, a method 200 is illustrated. The method 200 may be practiced in a computing environment. The method 200 includes acts for determining how to perform operations specified in executable code, the method includes accessing a language context (act 202). The language context is associated with a consumer location in executable code. For example, FIG. 1 illustrates the language context 106 as being associated with a consumer location of the executable code of the language 104. The code associated with the language context 106 specifies an operation to be performed on one or more objects. For example, the code associated with the language context 106 may specify an operation to be performed on the objects 108 and 110.

The method 200 further includes requesting information about how to perform the operation on the one or more objects (act 204). For example, a message may be sent to the language context 106 requesting information about how to perform the operation. The message may be embodied as a function call. In some embodiments, the method 200 may be performed such that requesting information about how to perform the operation comprises sending one or more of the arguments, but not necessarily all of the arguments, for the operation. For example, arguments including configuration parameters for the objects 108 and 110 may be included in the request for information. These arguments can be used to determine information in returned meta-objects as described below and/or with various caching operations.

The method 200 further includes receiving a meta-object with executable instructions or that produces executable instructions, that when executed perform the operation on the one or more objects (act 206). For example, the meta-object 120 may include executable code that can be executed to perform the operation. Alternatively, the meta-object 120 can produce executable code that can be executed to perform the operation.

In one embodiment, receiving a meta-object includes receiving a meta-object with information specified by the language context 106. For example, the language context 106 includes a meta-object 120 that may have information used in the received meta-object. It should be noted that different language contexts may include different information and may produce different meta-objects.

The method 200 may be practiced where receiving a meta-object with information specified by the language context comprises receiving a meta-object created by the language context that includes executable code created based on one or more meta-objects received from the one or more objects. For example, a meta-object 120 returned by the language context 106 may include information from the meta-object 112 and 114 for the objects 108 and 110 respectively. In one embodiment, to create the meta-object created by the language context that includes executable code created based on one or more meta-objects received from the one or more objects, the language context receives a request from the one or more objects for one or more requirements of the language context as the requirements relate to the operation. The language context then sends a message including one or more requirements of the language context as the requirements relate to the operation to the one or more objects. The language context then receives one or more meta-objects from the one or more objects. The one or more meta-objects from the one or more objects include executable code configured to take into account the one or more requirements of the language context.

The meta-object with instructions executed to perform the operation may obtain information for the instruction from a number of sources. For example, a received meta-object may include information specified by one of the one or more objects. Alternatively or additionally, a received meta-object may include information specified by one or more helper object provided by a dynamic language runtime. For example, the framework 102 may include a number of helper objects that are capable of providing one or more of the meta-objects of the set 116 of meta object. Alternatively or additionally, a received meta-object may include information specified by an extension. For example, extensions to objects, frameworks, languages, etc. may be used to obtain information for a meta-object.

As described previously, a meta-object may include a test specifying one or more conditions for when the executable code in the meta-object should be executed. As such, the method 200 may further include caching the meta-object. It can be determined that the specified one or more conditions have been met. As a result, the executable code in the meta-object is executed on a subsequent request to execute the operation based on determining that the specified one or more conditions have been met so as to avoid a subsequent request for information about how to perform the operation.

As described previously, a meta-object may include a validation method. The cache can now check if the test will never succeed. If it will never succeed in the future, then the cache can flush the current test from the cache.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of determining how to perform operations specified in executable code, the method comprising:
accessing a language context, wherein the language context is related to a consumer location in executable code, wherein the consumer location specifies an operation to be performed on one or more objects;
sending a message requesting information about how to perform the operation on the one or more objects; and
receiving a meta-object, the meta-object comprising or capable of producing executable code, that when executed performs the operation on the one or more objects.

2. The method of claim 1, wherein sending a message requesting information about how to perform the operation comprises sending one or more of the arguments for the operation.

3. The method of claim 1, wherein receiving a meta-object comprises receiving a meta-object with information specified by the language context.

4. The method of claim 3, wherein receiving a meta-object with information specified by the language context comprises receiving a meta-object created by the language context that includes or is capable of producing executable code created based on one or more meta-objects received from the one or more objects.

5. The method of claim 4, wherein to create the meta-object created by the language context that includes or is capable of producing executable code created based on one or more meta-objects received from the one or more objects, the language context performs the following:
receiving a request from the one or more objects for one or more requirements of the language context as the requirements relate to the operation;
sending a message including one or more requirements of the language context as the requirements relate to the operation to the one or more objects; and
receiving one or more meta-objects from the one or more objects, the one or more meta-objects from the one or more objects comprising or capable of producing executable code configured to take into account the one or more requirements of the language context.

6. The method of claim 1, wherein receiving a meta-object comprises receiving a meta-object with information specified by one of the one or more objects.

7. The method of claim 6, wherein the one or more objects are written in a different language than the language context.

8. The method of claim 1, wherein receiving a meta-object comprises receiving a meta-object with information specified by a helper object provided by a dynamic language runtime.

9. The method of claim 1, wherein receiving a meta-object comprises receiving a meta-object with information specified by an extension.

10. The method of claim 1, wherein the meta-object comprises a test specifying one or more conditions for when the executable code in the meta-object should be executed.

11. The method of claim 10, further comprising:
caching the meta-object;
determining that the specified one or more conditions have been met; and
as a result, executing the executable code in the meta-object on a subsequent request to execute the operation based on determining that the specified one or more conditions have been met so as to avoid a subsequent request for information about how to perform the operation.

12. In a computing environment, a method of determining how to perform operations specified in executable code, the method comprising:
accessing a language context, wherein the language context is related to a consumer location in executable code, wherein the consumer location in executable code specifies an operation to be performed on one or more objects;
accessing a meta-object, the meta-object comprising or producing executable code, that when executed performs the operation on the one or more objects; and
executing the code in or produced by the meta object to perform the operation.

13. The method of claim 12, wherein the language context and the one or more meta-objects are implemented in a plurality of different languages.

14. The method of claim 12, wherein the executable code in or produced by the meta-object comprises code generated from information received from at least one of the one or more objects.

15. The method of claim 12, wherein the executable code in or produced by the meta-object comprises code generated from information received from a helper object of a dynamic language runtime framework in which the language context is executed.

16. The method of claim 12, wherein the executable code in or produced by the meta-object comprises code generated from information received from an extension object of a language executing the language context.

17. The method of claim 12, wherein the meta-object comprises or produces a test specifying one or more conditions for when the executable code in the meta-object should be executed, the method further comprising:
caching the test and the executable code in or produced by the meta-object.

18. The method of claim 17, further comprising:
determining that the specified one or more conditions have been met; and
as a result, executing the executable code in or produced by the meta-object on a subsequent request to execute the operation based on determining that the specified one or more conditions have been met.

19. The method of claim 17, further comprising:
determining that the test will never succeed; and
as a result flushing the test from the cache.

20. In a computing environment, the computing environment comprising a dynamic language runtime, the dynamic language runtime comprising a framework for executing executable code, a method of determining how to perform operations specified in the executable code, the method comprising:
accessing a language context, wherein the language context is related to a consumer location in executable code, wherein the consumer location in executable code specifies an operation to be performed on one or more objects, wherein at least one of the one or more objects is written in a different language than the language context;
requesting information about how to perform the operation on the one or more objects; and
in response to requesting information about how to perform the operation, receiving a meta-object, wherein the meta-object comprises or produces:
executable code, that when executed performs the operation on the one or more objects;
test information specifying one or more conditions for using the executable code in the meta-object when subsequent instances of the operation are encountered; and
wherein the executable code is generated from information stored by the language context, and information received by the language context querying one or more of the one or more objects themselves for information about how to perform the operation, extension objects to the dynamic language runtime including information about how to perform the operation, or a language including the language context, wherein the language comprises objects including information about how to perform the operation.
